(19) United States
(12) Patent Application Publication
(10) Pub. No.: US 2013/0224526 A1
(43) Pub. Date: Aug. 29, 2013

(54) BATTERY PACK

(71) Applicant: Kumyul HWANG, Yongin-si (KR)

(72) Inventor: Kumyul HWANG, Yongin-si (KR)

(21) Appl. No.: 13/611,574

(22) Filed: Sep. 12, 2012

(30) Foreign Application Priority Data
Feb. 23, 2012 (KR) 10-2012-0018726

(51) Int. Cl. H01M 2/06; H01M 2/00; H01M 2/30

(52) U.S. Cl. 429/7; 429/156

(57) ABSTRACT

A battery pack includes a battery cell including an electrode assembly, a case accommodating the battery cell inside the battery pack, an external terminal at an upper outside portion of the case, the external case being electrically connected to the battery cell, the external terminal having a protruding end, a foreign substance receiver at the upper outside portion of the case, the foreign substance receiver being between the protruding end of the external terminal and the case being positioned to trap foreign substances generated at the external terminal, and a magnetic body installed inside the foreign substance receiver, the magnetic body being spaced apart from the external terminal.

### BACKGROUND

1. Field

Embodiments relate to a battery pack.

2. Description of the Related Art

In general, it may be difficult to adopt a single battery call as a power supply for electric equipment such as a notebook computer, an electronic device, an electric bicycle or an electric scooter. Therefore, a battery pack used as a power supply in such electric equipment or electronic device may include a plurality of battery cells connected in series/parallel.

### SUMMARY

According to embodiments, there is provided a battery pack including a battery cell including an electrode assembly, a case accommodating the battery cell inside the battery pack, an external terminal at an upper outside portion of the case, the external terminal being electrically connected to the battery cell and having a protruding end, a foreign substance receiver at the upper outside portion of the case, the foreign substance receiver being between the protruding end of the external terminal and the case and being positioned to trap foreign substances generated at the external terminal, a magnetic body installed inside the foreign substance receiver, the magnetic body being spaced apart from the external terminal.

The external terminal may be a clip type terminal, and may protrude in a direction toward or above the foreign substance receiver.

The foreign substance receiver may include a bottom portion shaped as a rectangular plate, and side portions upwardly extending from three edges of the bottom portion, the bottom portion and side portions being integrally formed.

The foreign substance receiver may have one open side and an open top portion. The protruding end of the external terminal may be positioned above the foreign substance receiver through the one open side.

The battery pack may further include a circuit board disposed between the external terminal and the case. A support portion for supporting a bottom of the circuit board may be provided at an end of at least one of the side portions of the foreign substance receiver.

The foreign substance receiver may further include barrier walls upwardly extending to form right angles with respect to the one open side. The foreign substance receiver may include a fixing slit at an exterior side of at least one of the side portions. The fixing slit may be coupled to a protrusion in the interior case such that the foreign substance receiver may be mounted in the interior case.

The magnetic body may be a rubber magnet. The magnetic body may be adhered to an inside of the foreign substance receiver by an adhesive tape. The magnetic body may be adhered to a top surface of the bottom portion of the foreign substance receiver.

The battery pack may further include a circuit board disposed between the external terminal and the case. The battery cell and the external terminal may be electrically connected to each other through a wire pattern in the circuit board. The external terminal may be coated with nickel, iron, cobalt, alloys thereof, or combinations thereof.

The battery pack may further include an external case accommodating the case and the external terminal, the external case having a terminal hole to expose the external terminal to an outside of the battery pack.

The battery pack may include a plurality of battery cells.

The battery cell may include a plurality of external terminals, each being a clip type terminal and protruding in a direction toward or above the foreign substance receiver.

### BRIEF DESCRIPTION OF THE DRAWINGS

Features will become apparent to those of ordinary skill in the art by describing in detail exemplary embodiments with reference to the attached drawings in which:

FIG. 1 illustrates a perspective view of an exemplary electronic device having a battery pack according to an embodiment mounted therein;

FIGS. 2A to 2C illustrate a perspective view, a plan view and a front view of a battery pack according to an embodiment, and FIG. 2D is a cross-sectional view taken along the line D-D′ of FIG. 2A;

FIGS. 3A and 3B illustrate a perspective view and a plan view of a case, a foreign substance receiver, an external terminal and a circuit board accommodated inside an external case of the battery pack shown in FIG. 2A;

FIG. 4 illustrates a perspective view of an exemplary foreign substance receiver mounted in the case shown in FIG. 2A; and

FIG. 5 illustrates a perspective view of another exemplary foreign substance receiver mounted in the case shown in FIG. 2A.

### DETAILED DESCRIPTION

Korean Patent Application No. 10-2012-0018726, filed on Feb. 23, 2012, in the Korean Intellectual Property Office, and entitled: “Battery Pack,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope thereof to those skilled in the art.

In the drawing figures, the dimensions of features may be exaggerated for clarity of illustration. Like reference numerals refer to like elements throughout.

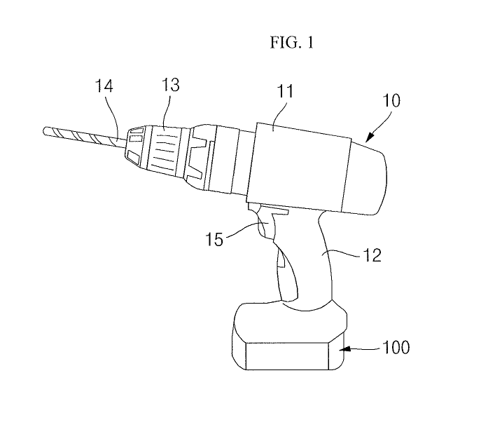

FIG. 1 illustrates a perspective view of an exemplary electronic device having a battery pack according to an embodiment mounted therein.

Referring to FIG. 1, the exemplary electronic device 10, such as, for example, a power tool, may include a housing 11 having a built-in rotation driver system and a handle 12 extending from the housing 11 in a substantially vertically downward direction. A driver bit 14, such as, for example, a drill bit, may be fixed to the housing 11 by a holder 13. The driver bit 14 may be driven by the rotation driver system incorporated in the housing 11. A switch trigger 15 is provided in the handle 12. If the switch trigger 15 is pressed, the rotation driver system is driven to rotate the driver bit 14.

The battery pack 100 may be mounted at a bottom end of the handle 12, and the rotation driver system may be driven by the power applied from the battery pack 100.

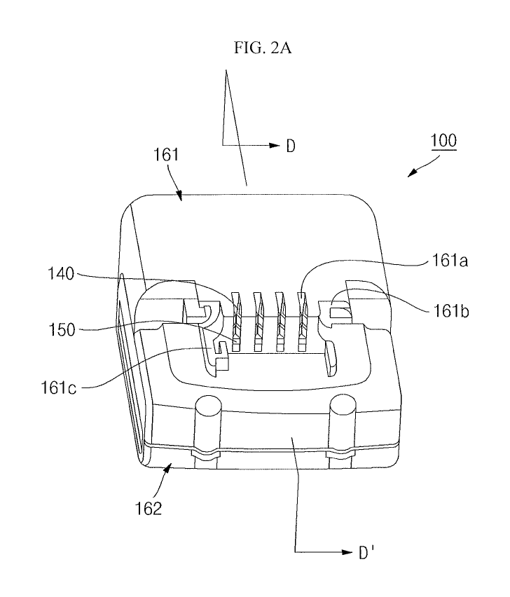

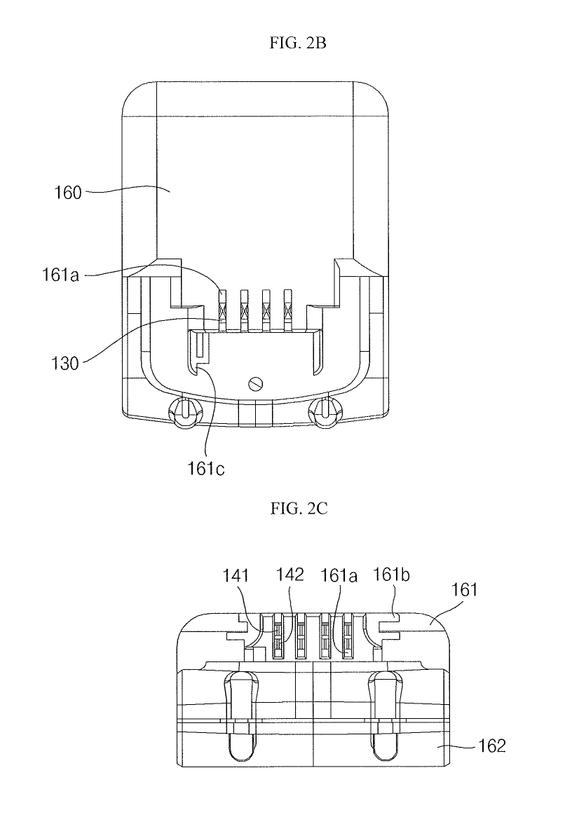

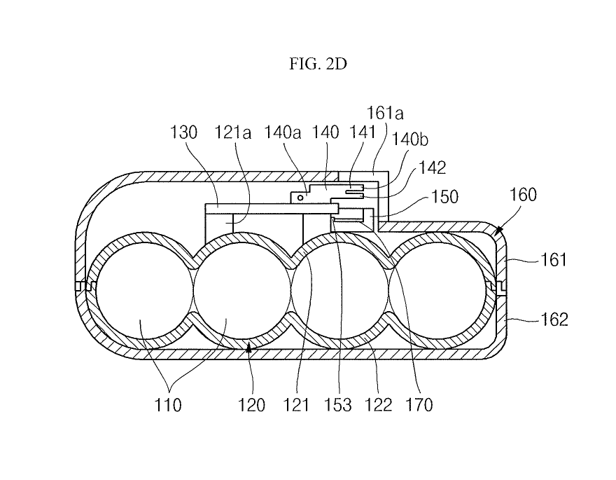

A configuration of the battery pack 100 will now be described with reference to FIGS. 2A to 2D.

FIGS. 2A to 2C illustrate a perspective view, a plan view and a front view of a battery pack according to an embodiment, and FIG. 2D is a cross-sectional view taken along the line D-D′ of FIG. 2A.

Referring to FIGS. 2A to 2D, the battery pack 100 may include a battery cell 110, an interior case 120, a circuit board 130, an external terminal 140, a foreign substance receiver 150 and an external case 160.

The battery cell 110 may be a rechargeable secondary battery. For example, a cylindrical lithium secondary battery cell having a high operating voltage of 3.6 V or greater and a high energy density per unit weight may be used as the battery cell 110. The battery cell 110 may be plural in number. While FIG. 1D illustrates four battery cells 110, in other implementations, other numbers of battery cells 110 may be provided. The plurality of battery cells 110 may have different polarities at their top and bottom surfaces, and adjacent battery cells 110 may connected in series using connection leads or connection plates (not shown).

Referring to FIG. 2D, the interior case 120 may have a top interior case portion 121 and a bottom interior case portion 122. In the interior case 120, the top interior case portion 121 and the bottom interior case portion 122 may be connected to or disconnected from each other to accommodate the battery cells 110 therein. The interior case 120 may be made of an insulating material such as plastic. In addition, guide rails 121a and 122a corresponding in shape to the plurality of battery cells 110 may be provided inside the interior case 120, thereby preventing the battery cells 110 from vibrating inside the interior case 120. In addition, the top interior case portion 121 may have at least two protruding parts 121b upwardly protruding. The protruding part 121b of the interior case 120 may be formed at a location corresponding to the edge of the circuit board 130, but aspects are not limited thereto.

The circuit board 130 may have a substantially plate-like shape and may be installed on the top interior case portion 121. The circuit board 130 may be mounted on the protruding part 121b upwardly extending from the top interior case portion 121 of the interior case 120. The circuit board 130 may be spaced apart from the top surface of the interior case 120 by a distance corresponding to a height of the protruding part 121b.

The circuit board 130 may be electrically connected to the battery cells 110 accommodated in the interior case 120 through a through-hole (not shown) formed in the interior case 120. The circuit board 130 may be a printed circuit board having a plate made of a resin, a wire pattern (not shown) and a plurality of electric circuits (not shown). The wire pattern of the circuit board 130 may be a pattern for electrically connecting the battery cells 110 to the external terminal 140. In addition, the electric circuits of the circuit board 130 may include a circuit (not shown) for controlling charging and discharging of the battery cells 110 and a protection circuit (not shown) for preventing over-charge/over-discharge.

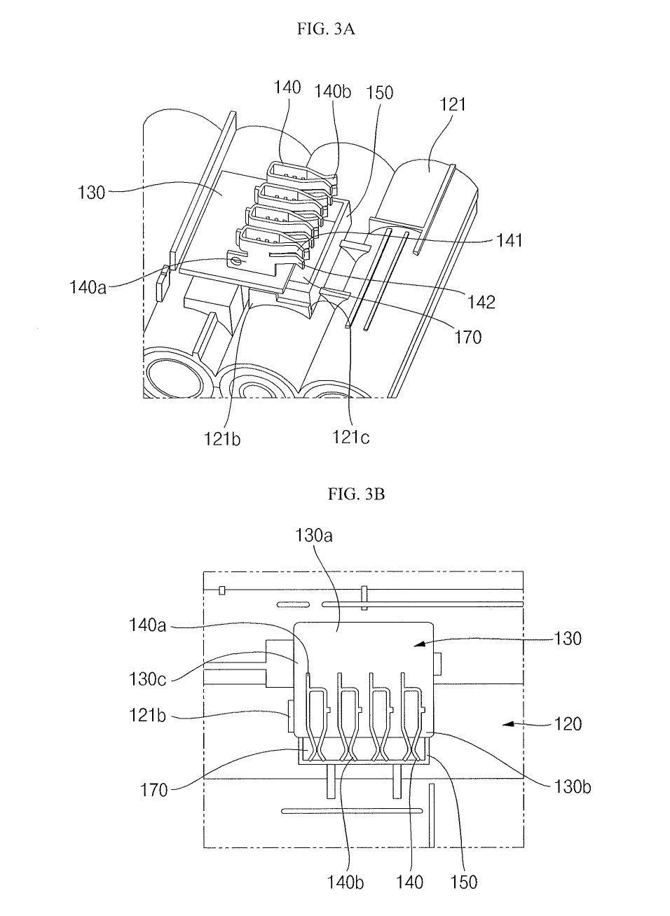

The external terminal 140 electrically connected to the circuit board 130 may be installed on the circuit board 130. The external terminal 140 may have a proximal side 140a fixed to the circuit board 130 and a distal side 140b shaped as a plane and protruding to the outside of the circuit board 130. An end of the distal side 140b of the external terminal 140 may be positioned on the foreign substance receiver 150. In addition, the external terminal 140 may be electrically connected to the wire pattern formed in the circuit board 130 and may be electrically connected to the battery cells 110 through the wire pattern. The external terminal 140 may be exposed to the outside of the external case 160 through the terminal hole 161a formed in the external case 160. In addition, the external terminal 140 may be formed as a clip type terminal to be engaged with a terminal of the electronic device 10 that may be in the shape of a bar. In addition, the external terminal 140 may include two clips 141 and 142 arranged in a vertical direction to increase a coupling force of the electronic device 10. The external terminal 140 may be electrically connected to the terminal of the electronic device 10 through the terminal hole 161. The battery pack 100 may supply power to the electronic device 10 through the external terminal 140. A configuration of the external terminal 140 is shown in detail in FIGS. 3A and 3B, which will be described below in detail.

The foreign substance receiver 150 may be installed at a lower portion of a region where the end of the distal side 140b of the external terminal 140 is positioned and may have a predetermined height. A magnetic body 170 may be mounted within the foreign substance receiver 150. A configuration of the foreign substance receiver 150 is shown in detail in FIGS. 3A and 3B, which will be described below in detail.

The external case 160 may have a top exterior case portion 161 and a bottom exterior case portion 162. The external case 160 accommodates the interior case 120, the circuit board 130, the external terminal 140 and the foreign substance receiver 150 as the top exterior case portion 161 and the bottom exterior case portions 162 are combined with each other. The top exterior case portion 161 may be formed with a step such that a top surface of one side is vertically higher than a top surface of the other side. The circuit board 130, the external terminal 140 and the foreign substance receiver 150 may positioned inside the exterior case 160 below the higher side of the top exterior case portion 161. The terminal hole 161 a may be provided at a protruding edge to expose the external terminal 140 accommodated within the external case 160 to the outside of the external case 160 by the step formed in the external case 160. The terminal hole 161a may be an “L” shaped slit formed at the protruding edge.

In addition, one or more fixing protrusions 161b and 161c may be provided in the top case 161 for coupling and fixing the top external case portion 161 to the electronic device 10. The fixing protrusions 161b and 161c may be formed on the outer periphery of the terminal hole 161a to be symmetrical to each other with respect to the terminal hole 161, but in other implementations, other configurations are possible.

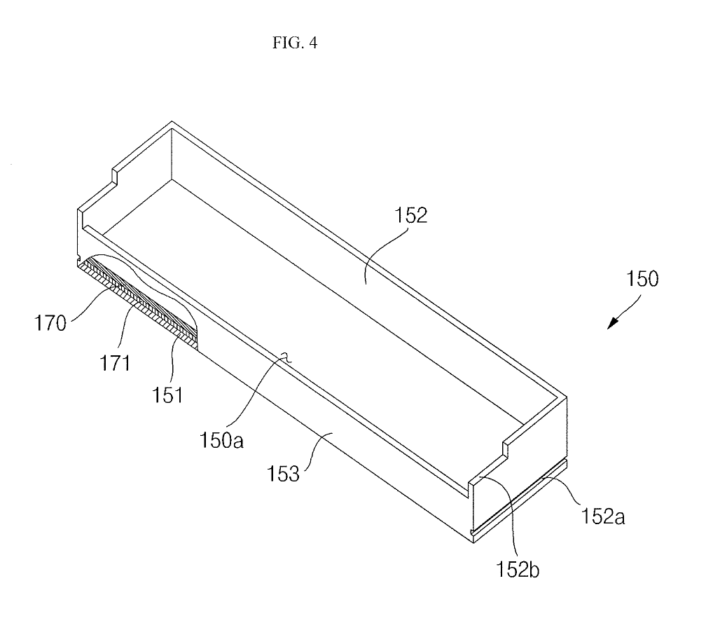

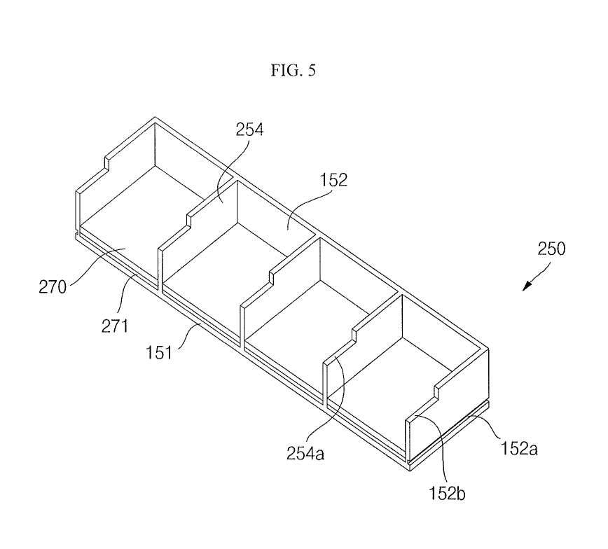

FIGS. 3A and 3B illustrate a perspective view and a plan view of the internal case 120, the foreign substance receiver 150, the external terminal 140 and the circuit board 130 accommodated inside the external case 160 of the battery pack 100 shown in FIG. 2A. FIG. 4 is a perspective view illustrating an exemplary foreign substance receiver 150 mounted in the exterior case 160 shown in FIG. 2A.

Hereinafter, configurations of the circuit board 130, the external terminal 140 and the foreign substance receiver 150 will be described with reference to FIGS. 3A, 3B, and 4.

The circuit board 130 may be mounted and fixed to the protruding part 121b formed on the interior case 120. The circuit board 130 may be spaced apart from the top surface of the top interior case 121 portion by the protruding part 121b by a distance corresponding to a height of the protruding part 121b. The circuit board 130 may have a substantially rectangular-plate shape having one edge 130a, another edge 130b parallel to the one edge 130a, and two side edges 130c connecting the one edge 130a to the other edge 130b in parallel. The protruding part 121b of the interior case 120 may support the two side edges 130c from the bottom. The protruding part 121b may also support the one edge 130a of the circuit board 130, but in other implementations, other configurations are possible.

The external terminal 140 mounted on the circuit board 130 may protrude toward the other edge 130b of the circuit board 130. In addition, the foreign substance receiver 150 may be mounted at a lower portion of the other edge 130b of the circuit board 130. The foreign substance receiver 150 may be mounted at a region corresponding to the lower portion of the external terminal 140 protruding to the other edge 130b of the circuit board 130.

The proximal side 140a of the external terminal 140 may be fixed to the circuit board 130 and the distal side 140b thereof may be formed as an elastic clip type terminal. The distal side 140b of the external terminal 140 may be an elastic clip type terminal in the shape of tongs. The clip type external terminal 140 may include two clips 141 and 142 arranged in a vertical direction. The vertically arranged clips 141 and 142 may increase a coupling force with respect to a bar-shaped terminal of an electronic device. The external terminal 140 may be plated with a magnetic metal such as nickel (Ni), iron (Fe), cobalt (Co), or alloys thereof.

In addition, the foreign substance receiver 150 may have a bottom portion 151 shaped as a rectangular plate and side portions 152 upwardly extending from three edges of the bottom portion 151 to have a predetermined height. The bottom portion 151 and the side portions 152 may be integrally formed. The side portions 152 and the bottom portion 151 together may form a “U” shape. In addition, the foreign substance receiver 150 may be configured to include one open side 150a, that is a side without a side surface, and an open top portion. The one open side 150a of the foreign substance receiver 150 may be positioned under the other side 130b of the circuit board 130. The distal side 140b of the external terminal 140 may be positioned above the foreign substance receiver 150 through the one open side 150a of the foreign substance receiver 150. In addition, the one open side 150a of the foreign substance receiver 150 may further include a partial side surface portion 153 for preventing foreign substances induced into the foreign substance receiver 150 from escaping from the foreign substance receiver 150 through the one open side 150a.

The end of the side portion 152 of the foreign substance receiver 150 may be formed stepwise, and the end may correspond to a support portion 152b for supporting the other side 130b of the circuit board 130. The support portion 152b, that is, the end of the side portion 152 of the foreign substance receiver 150, may be lower than the remainder of the side portion 152 of the foreign substance receiver 150. The support portion 152b may be formed to the same height as the protruding part 121b formed on the interior case 120. The support portion 152b of the foreign substance receiver 150 may support and fix the other side 130b of the circuit board 130 from the bottom.

In addition, the magnetic body 170 may be installed within the foreign substance receiver 150. The magnetic body 170 may be adhered to a top surface of the bottom portion 151 of the foreign substance receiver 150 using an adhesive tape 171. The magnetic body 170 may be made of a rubber magnet, such as a soft plastic magnet.

A fixing slit 152a may be formed on the side portions of the foreign substance receiver 150 that face each other. The foreign substance receiver 150 may be fixed to the interior case 120 by the fixing slit 152a. A protrusion 121c corresponding to the fixing slit 152a may further be formed in the interior case 120. The protrusion 121c may be formed on the side portion of the protruding part 121b formed in the interior case 120. The side portions 152 of the foreign substance receiver 150 facing each other may be supported using the protrusion 121c. The foreign substance receiver 150 may be slidably attached to/detached from the top surface of the interior case 120 using the fixing slit 152a.

The foreign substance receiver 150 may receive the foreign substance generated due to abrasion between the external terminal 140 of the battery pack 100 and the terminal of the electronic device 10 when the battery pack 100 is repeatedly attached to and detached from the electronic device 10. In addition, the foreign substance receiver 150 may have the magnetic body 170 provided therein. Accordingly, even if the battery pack 100 is moved, it may be possible to prevent the foreign substance created by abrasion of the external terminal from being introduced into the battery pack 100 by attaching and fixing the foreign substance on a surface of the magnetic body 170 using a magnetic force. The foreign substance between the terminals having magnetic and conductive properties may be prevented from being introduced into the battery pack 100 by the foreign substance receiver 150 and the magnetic body 170. Therefore, an electric short circuit due to the introduction of the conductive foreign substance may be prevented.

FIG. 5 illustrates a perspective view of another exemplary foreign substance receiver 250 mounted in the case shown in FIG. 2A.

Referring to FIG. 5, the foreign substance receiver 250 may be substantially the same as the foreign substance receiver 150 shown in FIG. 4 in view of configurations of the bottom and side portions. Therefore, the following description will focus on differences between the foreign substance receiver 150 shown in FIG. 4 and the foreign substance receiver 250 shown in FIG. 5, that is, barrier walls 254 of the foreign substance receiver 250. The barrier walls 254 may extend from the one open side of the foreign substance receiver 250 at a predetermined angle to be integrally formed with the side portion 152 and the bottom portion 151. The barrier walls 254 may be formed perpendicular to the one open side of the foreign substance receiver 250 to the same height as the side portion 152. A support portion 254a for supporting the other side 130b of the circuit board 130 may further be formed at an end of each of the barrier walls 254. The inside of the foreign substance receiver 250 may be divided into multiple compartments according to the number of the barrier walls 254 formed in the foreign substance receiver 250. A magnetic body 270 may be adhered to a top surface of the bottom portion 151 in each of the multiple compartments of the foreign substance receiver 250 using an adhesive tape 271. The magnetic body 270 may be formed to correspond in shape to the bottom portion 151 of each of the multiple compartments of the foreign substance receiver 250, and may be adhered to the top surfaces of the respective bottom portions 151 divided by the barrier walls 254.

By way of summation and review, when the battery pack used in the electronic device is repeatedly attached to or detached from a charger or electronic device to be charged or to drive the tool, the external terminals of the battery pack may be abraded. The external terminal may have conductivity. Accordingly, when foreign substance of the external terminal is introduced into the battery pack, a safety problem, such as an electric short circuit, may be generated.

The embodiments may provide a battery pack that can improve safety by preventing foreign substance generated due to abrasion of external terminals from being induced into the battery pack. In more detail, a foreign substance receiver may be provided at a lower portion of the external terminal of the battery pack. Accordingly, conductive foreign substances, which may be produced due to abrasion of the external terminal occurring when the battery pack is repeatedly attached to or detached from other devices, can be prevented from being induced into the battery pack.

In the battery pack according to embodiments, a magnetic body may be attached to the inside of a foreign substance receiver and the external terminal may be plated with a magnetic metal. Accordingly, the foreign substance abraded from the external terminal may have a magnetic property and may be adhered to the magnetic body provided inside the foreign substance receiver. Therefore, even if the battery pack is moved, the safety of the battery pack can be improved by preventing an electric short circuit that may otherwise be generated when the foreign substance is induced into the battery pack.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope as set forth in the following claims.

What is claimed is:

1. A battery pack, comprising:
a battery cell including an electrode assembly;
a case accommodating the battery cell;
an external terminal at an upper outside portion of the case, the external terminal being electrically connected to the battery cell and having a protruding end;
a foreign substance receiver at the upper outside portion of the case, the foreign substance receiver being between the protruding end of the external terminal and the case, and being positioned to trap foreign substances generated at the external terminal; and
a magnetic body installed inside the foreign substance receiver, the magnetic body being spaced apart from the external terminal.

2. The battery pack as claimed in claim 1, wherein the external terminal is a clip type terminal, and protrudes in a direction toward or above the foreign substance receiver.

3. The battery pack as claimed in claim 1, wherein the foreign substance receiver includes a bottom portion shaped as a rectangular plate, and side portions upwardly extending from three edges of the bottom portion, the bottom portion and side portions being integrally formed.

4. The battery pack as claimed in claim 3, wherein:
the foreign substance receiver has one open side and an open top portion, and
the protruding end of the external terminal is positioned above the foreign substance receiver through the one open side.

5. The battery pack as claimed in claim 4, further comprising a circuit board disposed between the external terminal and the case, wherein a support portion for supporting a bottom of the circuit board is provided at an end of at least one of the side portions of the foreign substance receiver.

6. The battery pack as claimed in claim 3, wherein the foreign substance receiver further includes barrier walls upwardly extending to form right angles with respect to the one open side.

7. The battery pack as claimed in claim 3, wherein the foreign substance receiver includes a fixing slit at an exterior side of at least one of the side portions, the fixing slit being coupled to a protrusion in the interior case such that the foreign substance receiver is mounted on the interior case.

8. The battery pack as claimed in claim 3, wherein the magnetic body is a rubber magnet.

9. The battery pack as claimed in claim 8, wherein the magnetic body is adhered to an inside of the foreign substance receiver by an adhesive tape.

10. The battery pack as claimed in claim 9, wherein the magnetic body is adhered to a top surface of the bottom portion of the foreign substance receiver.

11. The battery pack as claimed in claim 1, further comprising a circuit board disposed between the external terminal and the case, the battery cell and the external terminal being electrically connected to each other through a wire pattern in the circuit board.

12. The battery pack as claimed in claim 1, wherein the external terminal is coated with nickel, iron, cobalt, alloys thereof, or combinations thereof.

13. The battery pack as claimed in claim 1, further comprising an external case accommodating the case and the external terminal, the external case having a terminal hole to expose the external terminal to an outside of the battery pack.

14. The battery pack as claimed in claim 1, further comprising at least one fixing protrusion on the external case for coupling and fixing the external case to an electronic device.

15. The battery pack as claimed in claim 1, wherein the battery pack includes a plurality of battery cells.

16. The battery pack as claimed in claim 15, wherein the battery pack includes a plurality of external terminals, each being a clip type terminal and protruding in a direction toward or above the foreign substance receiver.
